(19) United States
(12) Patent Application Publication
(10) Pub. No.: US 2019/0324704 A1
(43) Pub. Date: Oct. 24, 2019

(54) MULTIUSER INTERACTIVE DISPLAY SYSTEM AND METHOD

(71) Applicant: Sensory Technologies LLC, Indianapolis, IN (US)

(72) Inventor: Sungwon Nam, Whitestown, IN (US)

(21) Appl. No.: 16/502,178

(22) Filed: Jul. 3, 2019

Related U.S. Application Data
(63) Continuation of application No. 15/063,564, filed on Mar. 8, 2016.
(60) Provisional application No. 62/130,380, filed on Mar. 9, 2015.

(51) Int. Cl. G06F 3/14; H04L 29/06

(52) U.S. Cl. CPC G06F 3/1446; G06F 3/1415; H04L 65/4015; G09G 2370/022; G09G 2300/026; G09G 2370/045; H04L 65/403

(57) ABSTRACT

A synchronous multi-user display wall system for displaying multimedia contents provided by a plurality of computing devices each interacting with the display wall system at the discretion of a user. The synchronous display wall system includes one or more single or tiled-display wall and one or more servers operatively coupled to the display walls and to the plurality of computing devices. The system is configured to enable each of the users to concurrently display information on the display wall, as well as to enable concurrent interaction by each of the users with the displayed information. The system is configured further to enable synchronization of content displaying on the display wall with other display wall system that are connected over the same network. A method for multiple users to concurrently interact with shared media that is displayed, and a multiuser interactive display system that can synchronize with other display systems is described.

### RELATED APPLICATION

This application is a continuation-in-part patent application of patent application Ser. No. 15/063,564, filed Mar. 8, 2016, having the title “Multiuser Interactive Display System and Method”, which claims priority to U.S. Provisional Patent Application Ser. No. 62/130,380 entitled “Multiuser Interactive Display System and Method”, filed Mar. 9, 2015, both of which are incorporated herein by reference in their entirety.

### BACKGROUND

The present disclosure relates to systems and methods for providing a multiuser interactive display system that can synchronously operate with remote display wall systems. The multiuser interactive display system enables multiple users to share the same computer-based graphical workspace, share individual content, and interact with the shared contents concurrently in a virtual graphical desktop environment.

The ability to interpret and digest various digital data and information produced by various sources is important. As huge amounts of digital data and information are generated every day at continually increasing volumes, the need exists for an effective way to present these information and data for easy filtering, comparison and analysis.

Ultra-high resolution single panel monitors and large-scale tiled display walls are often used for information and data presentations of, for example, images, video, pdf documents, live streams (including audiovisual conferencing), and other types of media files.

Traditionally, large-scale tiled display walls could only be built with a cluster of computers. This requirement has been the major barrier that prevents wider range of users from adapting or transitioning to display wall technologies, due to the cost and complexity required to build and maintain a computer cluster. With the advent of modern multi-headed graphics hardware, however, users can now more easily build ultra-high resolution display walls. FIG. 1A shows an example of a 4×3 display wall 20 defined by twelve 1080p (1920×1080 pixels) display units 22 which may be high-definition TV units. The respective display units 22 in display wall 20 are enumerated 1-12 in FIG. 1A.

Display units 22 can be run by a single workstation with hardware that includes multiple head high-end graphics cards. Major graphics hardware manufacturers such as NVIDIA, AMD, and Matrox, for example, provide multi-head graphics display technologies, such as NVIDIA Mosaic, AMD Eyefinity, and Matrox PowerDesk. Any of these products can enable generation of a single virtual desktop screen over the array of tiled, multiple display units 22 to provide a single, ultra-high resolution graphical workspace on a virtual screen defined by display wall 20. Display wall 20 can thus comprise a tiled array of high definition display units 22 over which seamlessly spans a large, ultra-high resolution display 24. Alternatively, display 24 may be provided on a single panel monitor, which may be a single one of display units 22.

FIG. 1B shows a fragmented, partial view of a single workstation or personal computer (“PC”) 26 having three four-head NVIDIA Quadro K5200 graphics cards 28, 30 and 32. The four outputs of each graphics card 28, 30, 32 are each connected by a respective cable to a particular one of enumerated display units 22 of FIG. 1A, and are accordingly enumerated with a corresponding output number 1-12. Assuming each display unit 22 of display wall 20 is a typical high-definition TV (1920×1080 resolution), the total resolution of the display wall is 7680×3240 pixels. The tiled display wall 20 can thus enable the display of numerous high-resolution images and videos displayed in their native resolution simultaneously. Alternatively, workstation 26 may include a single graphics card connected to a single panel monitor. The discussion that follows relates to a workstation and display wall as depicted in FIGS. 1A and 1B, but generally applies as well to the case of a workstation connected to a single panel monitor.

Traditional graphical desktop operating systems are designed based on the assumption that a single user physically interacts with the workstation 26 using a keyboard and a mouse (not shown). There can be multiple different user accounts and multiple users can remotely login simultaneously. However, multiuser collaboration where multiple users sit together in the same room and simultaneously interact with contents displayed on a single common display wall is highly limited because only a single user can directly interact with graphical contents on PC 26. In other words, such graphics desktop operating systems are presently designed for a single user interaction scheme, in which a single user owns the graphical desktop environment. A user gains access to a desktop session of a computer system by logging in with his user credential, which enables a shared system to provide each user a separate private workspace. Once a user has logged in, the desktop session is owned by the user. Therefore, this traditional design does not allow multiple users to login to the same graphical desktop workspace concurrently. Such systems are limited in that they allow only the single user currently logged in to the PC 26 to access the graphical contents he shares and have the ability to interact with that content. When such a PC is attached to display wall 20, the display wall's potential as a multiuser collaborative environment remains similarly limited. Display wall systems utilizing the traditional scheme (i.e., a graphical desktop space owned by a single user) that allow contents from separate sources to be visualized simultaneously can limit the collaboration capability of the display wall environment.

It is desirable to resolve this limitation, and provide a single virtual graphical desktop environment in which multiple users can simultaneously login to and share the same workspace, share individual content, and concurrently interact with the shared contents on a large-scale shared displays.

Many user environments or forums would benefit from the provision of such a virtual graphical desktop environment. One such example is education. The classroom environment is changing rapidly as students rarely absorb lectures passively from their desks. Decades of research speak to the educational benefits of active learning; however, this paradigm shift in how information is shared, created and exchanged challenges those seeking to provide rich learning experiences. These challenges can be met by providing a virtual blackboard where instructors and students could share various media simultaneously and concurrently interact with the media, enhancing the learning experience. Such an interactive graphical desktop environment can be further enhanced by being adapted to include a large-scale display wall instead of or in addition to a single panel monitor.

Another user environment or forum that stands to benefit from utilizing such an interactive graphical desktop environment is business enterprise. The “more heads are better” philosophy is widely accepted by businesspeople, and the benefits of collaboration by individuals with a sense of shared purpose are well documented. Businesses could more effectively generate, funnel and capture the collaborative synergy while it happens by utilizing a highly collaborative virtual graphical desktop environment capable of displaying digital content from multiple sources in various formats that allows multiple users to instantly share information, and annotate the shared content simultaneously. Facilitating such multiuser collaboration could greatly improve business productivity, more so if it also involves use of a large-scale display wall instead of or in addition to a single panel monitor.

In the era of big data, synthesizing information challenges the most expert thought leaders. Even more difficult can be the task of communicating aggregate insights concurrently contributed from multiple sources to others needing to understand the big picture. Thus, another user environment or forum that could benefit from facilitating such collaboration by multiple specialists is healthcare.

### SUMMARY

The present disclosure beneficially provides a multiuser interactive display system that enables improvements in the abilities of individuals and groups, whether they are physically located in the same place or not, to interpret and digest digital data and information in a collaborative session. The display system may include a single panel monitor, or be adapted to include a large-scale display wall. In one or more embodiments, each of the display systems includes a server such that the server is integrated with the single panel monitor or with the large scale display wall to operate as a complete integrated device. Two or more of these display systems operate together and interdependently to provide a synchronized display wall environment, wherein display wall systems are located at different locations.

Moreover, the collaboration capability of the display wall environments is extended to users even when the users are not physically located in the same room, or even the same location, by enabling shared workspaces running on large-scale display walls to mirror each other.

The disclosed multiuser interactive display system (the “system”), an embodiment of which may become known as Thrive™, includes a computer software package designed to improve multiuser collaborative experiences in an environment having a single panel monitor and/or a large, ultra-high resolution tiled display wall. The system achieves this by allowing multiple users to share the same graphical workspace and interact with contents in the workspace simultaneously while maintaining awareness of content ownership and being able to distinguish between each user's interactions with the respective content. The system also achieves synchronized display wall states across multiple display walls by employing a synch client/synch server relationship where the system includes a synch server that informs changes to the remaining systems, identified as synch clients, to have a synchronized display wall state among a plurality of display wall systems.

The system software consists of two independent applications: the system software server (system server) and the system software client (system client). The system server runs in a high-performance graphics workstation that, in certain embodiments, is connected to the multiple display units of a display wall. In such embodiments, the system server provides a single virtual graphical desktop workspace that seamlessly spans across the tiled display units. Alternatively, the workstation is connected to a ultra-high resolution single panel monitor providing the same graphical workspace in a smaller dimension. Regardless of the display configuration, the system software enables multiuser interactivity. The system client runs in each user's individual input device (typically a laptop) and is used to communicate (preferably wirelessly) with the system server for the users to share content displayed on the display wall, and remotely interact with shared content using their respective individual input devices.

The disclosed system facilitates a highly collaborative, shared workspace because it displays multiple digital contents simultaneously to the collaborating users, and remote systems where those collaborating users are located, and allow the users to interact with the various displayed contents concurrently.

In one embodiment, there is provided a method for manipulating the display of information shown on a video display including, receiving at a server, a plurality of transmitted information files, each of the plurality of transmitted information files begin transmitted by a different one of a plurality of computing devices. The method includes establishing at the server a plurality of communication channels, wherein each of the plurality of communication channels is dedicated to a different one of the plurality of computing devices. The method further includes retaining each of the plurality of transmitted information files on the Cloud storage and displaying each of the plurality of transmitted information files concurrently on the display and synchronize the states of the contents among all the display wall systems.

In another embodiment, there is provided a method for processing multiple user interactions with information shown on a video display wall including storing at a server a plurality of information files transmitted by a plurality of computing devices. The method further includes displaying on the display wall each of the plurality of stored information files and associating one of a plurality of graphical user interface components with a specific one of the plurality of computing devices. The method also includes displaying on the display wall the graphical user interface component for each of the plurality of computing devices, wherein the displayed graphical user interface component is directly controlled by the associated one of the plurality of computing devices.

In still another embodiment, there is provided a video display wall system for displaying information provided by a plurality of computing devices each interacting with the video display wall system at the discretion of a user including a display wall and a system server. The system server is operatively coupled to the display wall and to the plurality of computing devices. The system server includes a communication manager, configured to receive a plurality of transmitted interaction messages from each of the plurality of computing devices, a file manager, a scene renderer and a multiuser interaction manager. The file manager is configured to receive a media file from each of the plurality of computing devices. The scene renderer is configured to render the media file from each of the plurality of computing devices for display on the display wall as the video information. The multiuser interaction manager is configured to direct interactions of each of the plurality of the computing device with the displayed video information based on the received interaction messages. A synchronization manager is configured to run the system in either a synch client mode or a synch server mode. When the system server is run as the synch client, the system pushes its changes to the synch server. When the system server is run as the synch server, the system receives changes from synch clients and pushes those changes to the remaining synch clients.

In further embodiment there is provided a method for synchronizing a visualization layout of a media file for multiple display wall systems running multi-user, multi-content enabled display walls, each display wall system including a display wall and a system server and each of the display wall systems serving a plurality of local users. The method includes: identifying one of the system servers as a synch server; identifying each of the other system servers as a synch client; establishing, at the synch server, a plurality of synch message channels, wherein one synch message channel is maintained by the synch server for each synch client, and each of the synch message channels is configured to transmit a synch message to the synch client; and updating a display wall content of the display wall for each of the synch clients.

In an additional embodiment, there is provided a media file display wall system for displaying one or more media files provided by a plurality of computing devices each interacting with the media file display wall system at the discretion of a user. The system includes a first display wall having a synch server, wherein the synch server is operatively connected to the first display wall, to one or more first user input devices, and to a cloud network. A plurality of second display walls each includes a synch client, wherein each of the synch clients is operatively connected to one or more second user input devices and to the cloud network. A plurality of synch message channels are maintained by the synch server and each of the plurality of synch message channels is operatively connected to one of the plurality of synch clients, wherein the synch message channels transmit an updated message to update the media file located at each of the plurality of second display walls, except to the synch client of the one of the plurality of display walls transmitting the message to the synch server.

In another embodiment, there is provided a method for synchronizing media file visualization states of media files for multiple display wall systems each running multi-user, multi-content enabled display walls, wherein each of the display wall systems is operatively connected to a plurality of local users each having an input device. The method includes: receiving, at a first display wall of the display wall systems, a connection request from a second display wall of the display wall systems, wherein the connection request requests the first display wall to operate in a synch server mode; determining, at the first display wall, whether the first display wall is operating in a synch client mode; accepting, at the first display wall, the connection request to operate in the synch server mode, if the first display wall is not operating in the synch client mode; and not accepting, at the first display wall, the connection request to become the synch server, if the first display wall is operating in they synch client mode.

### BRIEF DESCRIPTION OF THE DRAWINGS

The above-mentioned aspects and other characteristics and advantages of a method or system according to the present disclosure will become more apparent and will be better understood by reference to the following description of exemplary embodiments taken in conjunction with the accompanying drawings, wherein:

FIG. 1A depicts a 4×3 tiled display wall utilized in an embodiment of the disclosed system, wherein each display unit is a typical high-definition TV and over which is provided a single virtual desktop screen;

FIG. 1B is a fragmented, partial view of a single workstation utilized in an embodiment of the disclosed system for driving the display wall of FIG. 1A;

FIG. 2 is a schematic representation of a multiuser interaction scheme according to an embodiment of the disclosed system;

FIG. 3 is schematic representation of an embodiment of the system software structure showing major software modules included in the system server and each system client;

FIG. 4 is a multiuser interaction and multi-display wall synchronization diagram for an embodiment of the disclosed system;

FIG. 5A is a block diagram of a process for a synchronization procedure of a system that becomes a synch client by connecting to a remote system;

FIG. 5B is a block diagram of a process for a synchronization procedure of a system that becomes a synch server upon receiving and accepting a connection from a remote system;

FIG. 6A shows two independent display wall systems that are not synchronized, thus each display wall displays its own contents;

FIG. 6B shows two display wall systems that are synchronized whereby both walls display the synchronized contents;

FIG. 7A depicts one of the synch clients sending a synchronization message to the synch server; and

FIG. 7B depicts the synch server, upon receiving the synchronization message, sends the synchronization messages to all the synch clients except the one that sent the original synchronization message.

Corresponding reference characters indicate corresponding parts throughout the several views.

### DESCRIPTION

The embodiments described below are not intended to be exhaustive or to limit the invention to the precise forms or steps disclosed in the following detailed description, but have been chosen and are herein described so that others skilled in the art may appreciate and understand principles and practices according to the present disclosure, and may utilize their teachings. It is, therefore, to be understood that the invention herein described is not limited in its application to the details set forth in the following description or illustrated in the following drawings, and is capable of having other embodiments and of being practiced or of being carried out in various ways.

The present disclosure may be practiced with “object-oriented” software, and particularly with an “object-oriented” operating system. The “object-oriented” software is organized into “objects,” each typically including a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and having knowledge to carry out processes. Messages are generated in response to user instructions, for example, by a user activating an icon with a “mouse” pointer and thereby generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of an object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by messages effects an object-oriented program. Object-oriented computer programming facilitates the modeling of interactive systems in that each component of the system is modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences and combinations of message and response may continue or may come to an end when all messages have been responded to and no new messages are being sent. When modeling systems utilize an object-oriented language, a programmer need only think in terms of how each component of a modeled system responds to a stimulus and not in terms of the sequence of operations to be performed in response to some stimulus. Such a sequence of operations naturally flows out of the interactions between the objects in response to the stimulus, and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works by simply observing the readily apparent manifestations of its operation. Most of the operations carried out by a computer in response to a program are “invisible” to an observer because typically only a relatively few steps in a program produce an observable computer output.

Several terms which are used frequently have specialized meanings in the present context. The term “object” relates to a set of computer instructions and associated data which are activated directly or indirectly by the user. The terms “windowing environment,” “running in windows,” and “object-oriented operating system” are used to denote a computer user interface in which information is manipulated and displayed on a video display such as within bounded regions on a raster scanned video display. The terms “network,” “local area network,” “LAN,” “wide area network,” and “WAN” refer to two or more computers which are connected so that messages may be transmitted between the computers. In such computer networks, typically one or more computers operate as a “server,” a computer with large storage devices such as hard disk drives and communication hardware to operate peripheral devices such as display walls, printers or modems. Other computers provide a user interface so that users of computer networks are able to access network resources, such as shared data files, common peripheral devices, and inter-computer communication. Users activate computer programs or network resources to create “processes” which include both the general operation of the computer program along with operations having specific characteristics determined by input variables and environment.

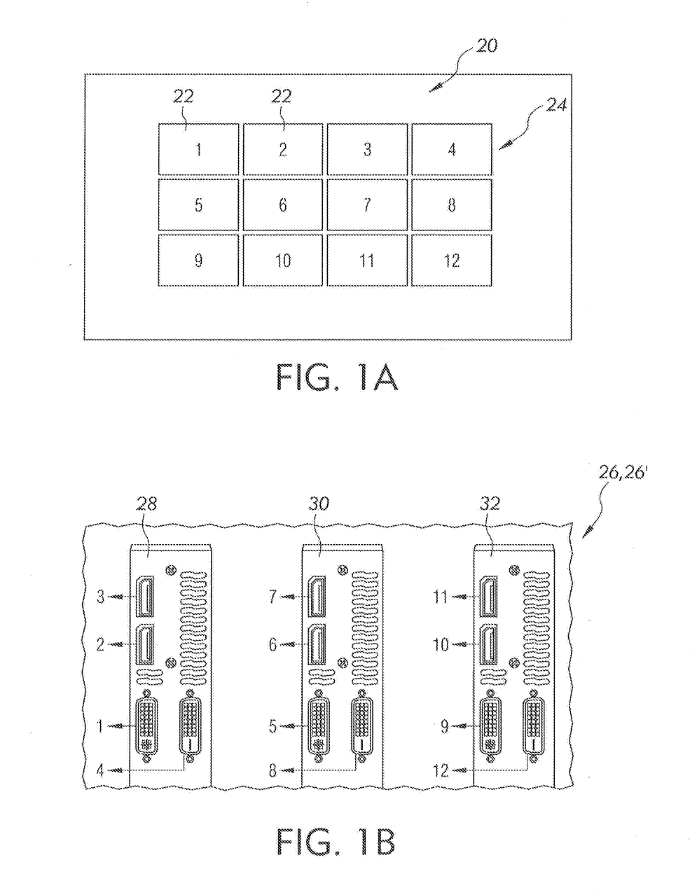

The embodiment of multiuser interactive display system 18 (i.e., system 18 or “the system”) described herein includes display wall 20 as described above. It is to be understood, however, that certain embodiments of system 18 may be adapted to instead or additionally include one or more single panel monitors to provide display 24. System 18 also utilizes a single workstation or PC 26′, a portion of which is shown in FIG. 1B. Workstation 26′ is structurally similar to above-described workstation 26, and may include identical hardware such as four-head NVIDIA Quadro K5200 graphics cards 28, 30 and 32. As in the case with prior workstation 26, the four outputs of each graphics card 28, 30, 32 of workstation 26′ are each connected by a respective cable to a particular one of enumerated display units 22 of display wall 20 shown in FIG. 1A. The graphics card outputs of workstation 26′ are likewise accordingly enumerated 112. Workstation 26′ differs significantly from prior workstation 26, however, in that workstation 26′ includes system software enabling it to function as a system server of system 18 (the “system server”, or system server 46). Other display walls 20 or display units 22 include what is known as a 4K display having high definition resolutions of 3840×2160 pixels or 4096×2160 pixels. Other resolution display walls and displays are contemplated including those having higher resolution.

The multiuser interaction model of system 18 provides a virtual graphical desktop session (a workspace) to which multiple users login, share contents, and interact concurrently. There are two fundamental premises of enabling multiuser interactivity:

(1) A mechanism is provided that concurrently receives multiple users' interaction messages and execute those interactions. This premise provides a notion of the shared desktop workspace where each participating user uses his own input device/laptop to interact with the shared content.

(2) Graphical objects appearing on the display wall are concurrently interacted with, and the system server is aware of which user is interacting with those graphical objects. This premise maintains ownership information of the media and the interactions in the shared workspace where different users share and interact simultaneously.

Thus the core of the multiuser collaborative environments enabled by system 18 consists of the mechanism that allows multiple users to stream their input device events concurrently and the newly designed graphical user interface (GUI) components that are aware of multiuser interactions on them.

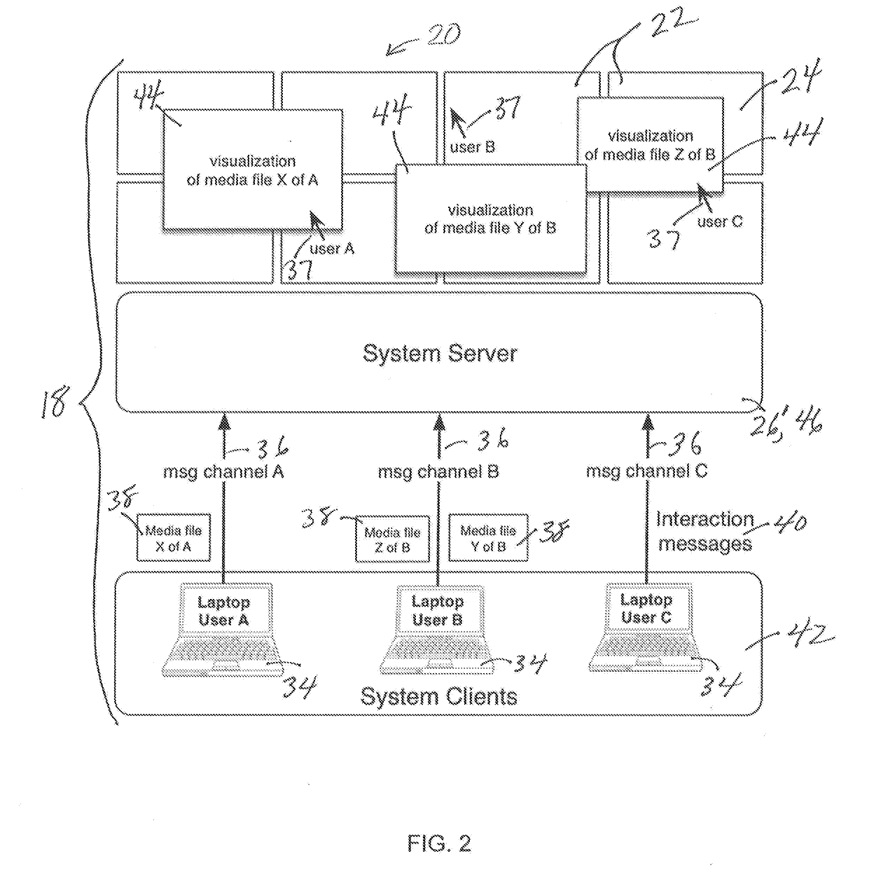

FIG. 2 shows an example multiuser interaction scheme. In this example three users utilizing input devices 34 such as laptop computers (individually referred to as Laptop Users A, B, and C) are sharing their media with display wall 20 (FIG. 1A) run by single workstation 26′ (FIG. 1B). Transmission of the shared media from each respective Laptop User A, B or C to workstation 26′ is over an associated wireless communication channel 36 (respectively referred to as channel A, B or C). Whenever a user connects to system server 46 of workstation 26′ a dedicated communication channel 36 is established between the system server and that user. The system server also creates a graphical mouse pointer 37 for that user upon establishment of the dedicated communication channel 36, and these graphical pointers work the same as mouse pointers in a traditional graphical desktop environment. By establishing a dedicated communication channel for each user, ownership information about the shared media files 38, interaction messages 40, and graphical mouse pointers 37 are retained in system server 46.

The users interact with the displayed shared media visualizations 44 using their respective individual input devices 34 connected to or built in their laptops. Each laptop 34 runs the system software client, which enables the laptop to function as one of a plurality of system clients 42. In the depicted example, Laptop User A and Laptop User B share media files 38 using the respective laptop's system client 42. The shared media files 38 are, as shown, media file X shared by Laptop User A, and media files Y and Z shared by Laptop User B. These media files 38 are transmitted over the respective wireless communication channels 36 to the workstation 26′ where system server 46 is running. System server 46 then provides visualizations 44 of those media on display wall 20.

The interactions of each user with the shared media visualizations 44 occur in the user's respective input device/laptop 34 in real time. In this example, Laptop User A and C respectively interact with media visualization X and media visualization Z. The respective system client 42 translate the user interactions of Laptop User A and Laptop User C occurring in their devices in real time and transmit them as interaction messages 40 over the respective wireless channel A or C to system server 46. Upon receiving these interaction messages 40, system server 46 interprets the interaction messages 40 and correspondingly interacts with the media visualizations 44 displayed in a visualization layout on display wall 20 on behalf of the particular user from whom the interaction message 40 was sent. In the depicted example, system server 46 interacts with media visualization X (shared by Laptop User A) on behalf of Laptop User A, and with media visualization Z (shared by Laptop User B) on behalf of Laptop User C.

Multiple (two or more) display wall systems are synchronized for two-way communication between two or more system servers, each one being with its respective display wall system, with one system server being identified as a synch server and each of the remaining system servers being identified as a synch client such that one or more synch client servers are communicatively connected to a single system synch server. Each of the display wall systems and its associated server are configured to transmit and receive information with any other of the display wall systems, and its associated server, based on a communication protocol that identifies one of the system servers as a synch server and each of the remaining system servers as a synch client. Consequently, each of the system servers 46 operate in one of a synch client mode or synch server mode depending on which system server initiates a connection request message first, by being the first of the system servers to transmit a connection request message.

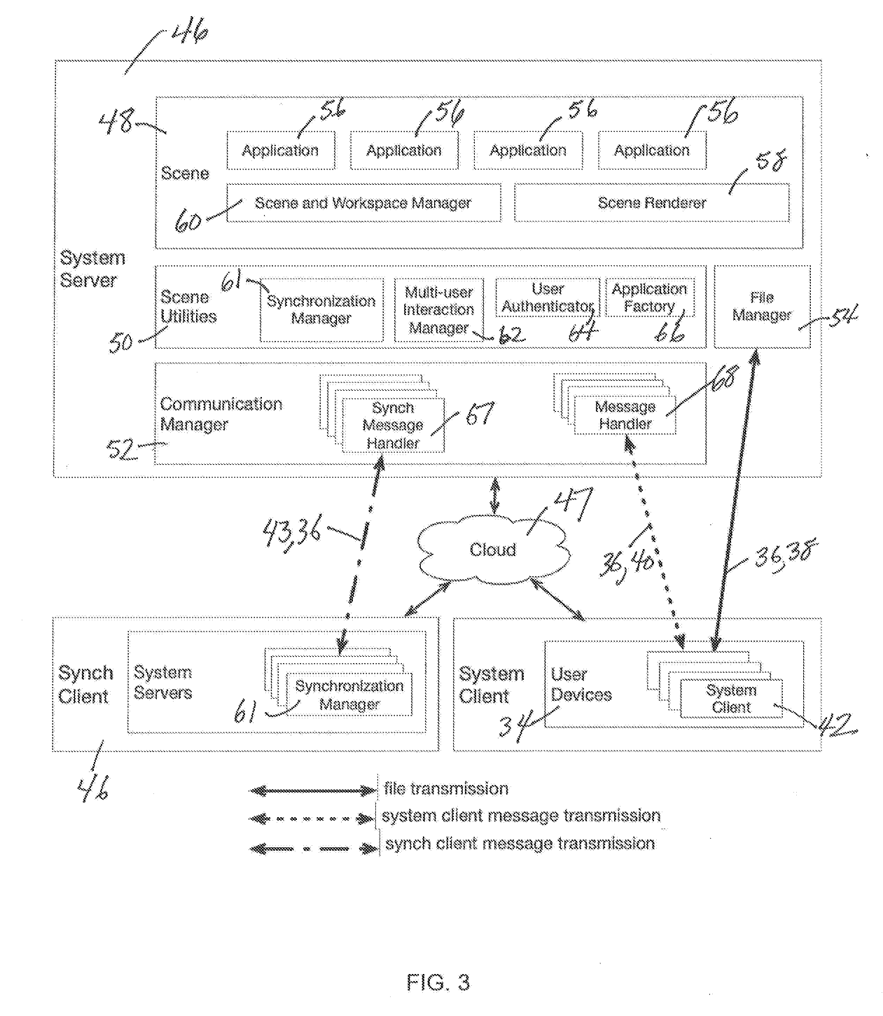

Each of the system servers communicates through a Cloud server network having one or more Cloud servers 47 as illustrated in FIG. 3. The Cloud server network is known as the “Cloud” and includes one or more servers having one or more processors and associated memory. The processors are configured to execute or otherwise rely upon computer software applications, components, programs, program code, objects, modules, or data structures, etc. Software routines resident in the memory are executed in response to the signals provided by the processor. Then memory is configured to store the computer software application as well as data.

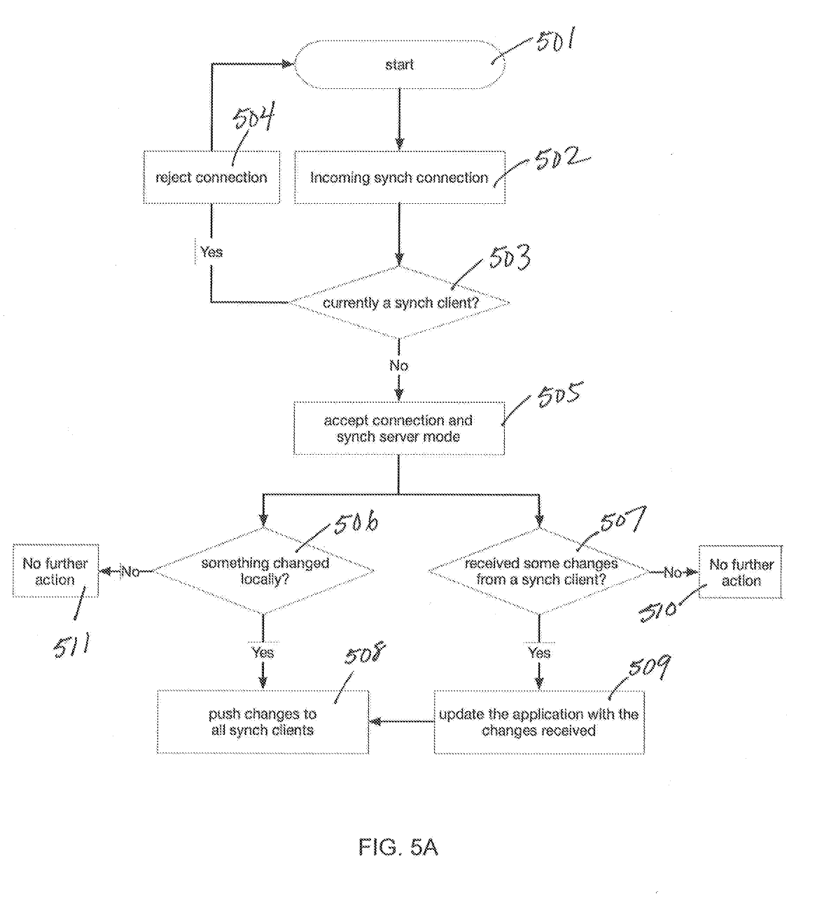

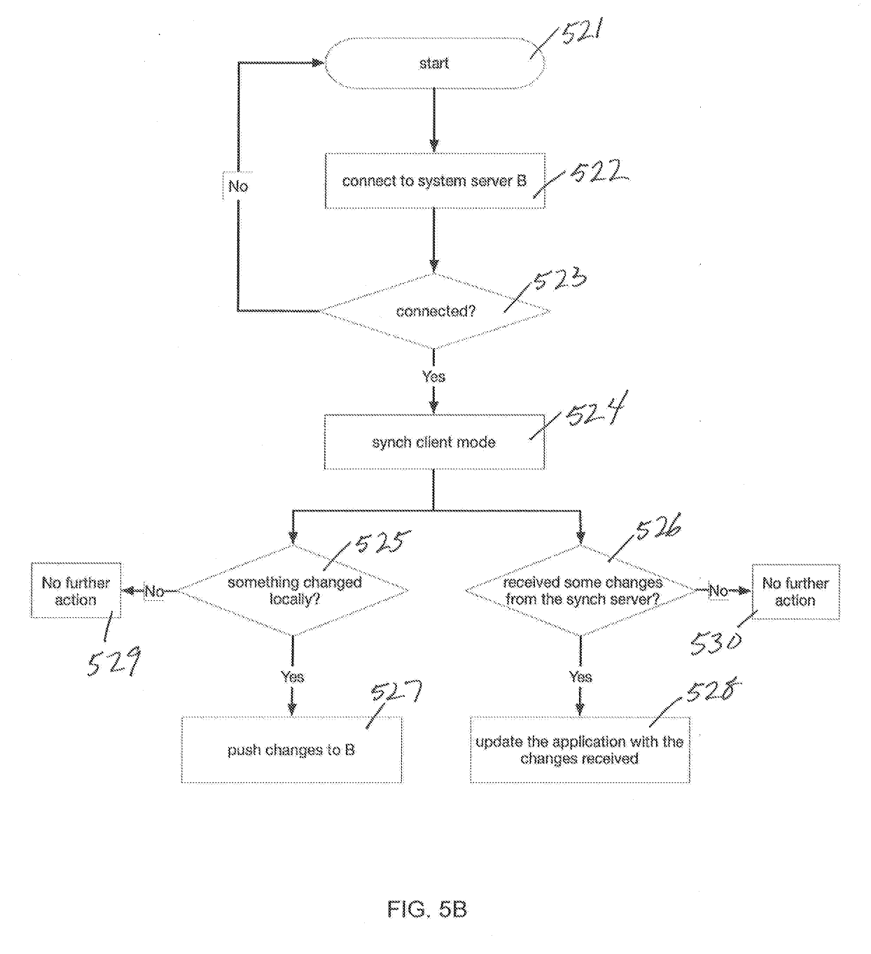

The Cloud server 47 may be embodied as a “serverless” or server-ambiguous computing solution, for example, that executes a plurality of instructions on-demand, contains logic to execute instructions only when prompted by a particular activity/trigger, and does not consume computing resources when not in use. That is, the Cloud server 47 may be embodied as a virtual computing environment residing “on” a computing system (e.g., a distributed network of devices) in which various virtual functions (e.g., Lambda functions, Azure functions, Google Cloud functions, and/or other suitable virtual functions) may be executed corresponding with the functions of the Cloud server 47 described herein. For example, when an event occurs (e.g., data is transferred to the Cloud server 47 for handling), the virtual computing environment may be communicated with (e.g., via a request to an application programming interface (API) of the virtual computing environment), whereby the API may route the request to the correct virtual function (e.g., a particular server-ambiguous computing resource) based on a set of rules. As such, when a request for the transmission of particular data is made (e.g., via an appropriate interface to the Cloud server 47), the appropriate virtual function(s) may be executed to perform the actions before eliminating the instance of the virtual function(s). Although the Cloud server 47 is described herein as a Cloud-based device, it should be appreciated that the Cloud server 47, in different embodiments, is embodied as, or includes, one or more servers located “outside” of a Cloud computing environment in other embodiments. The synch server/synch client selection mechanism is depicted in FIGS. 5A and 5B and is further described later herein.

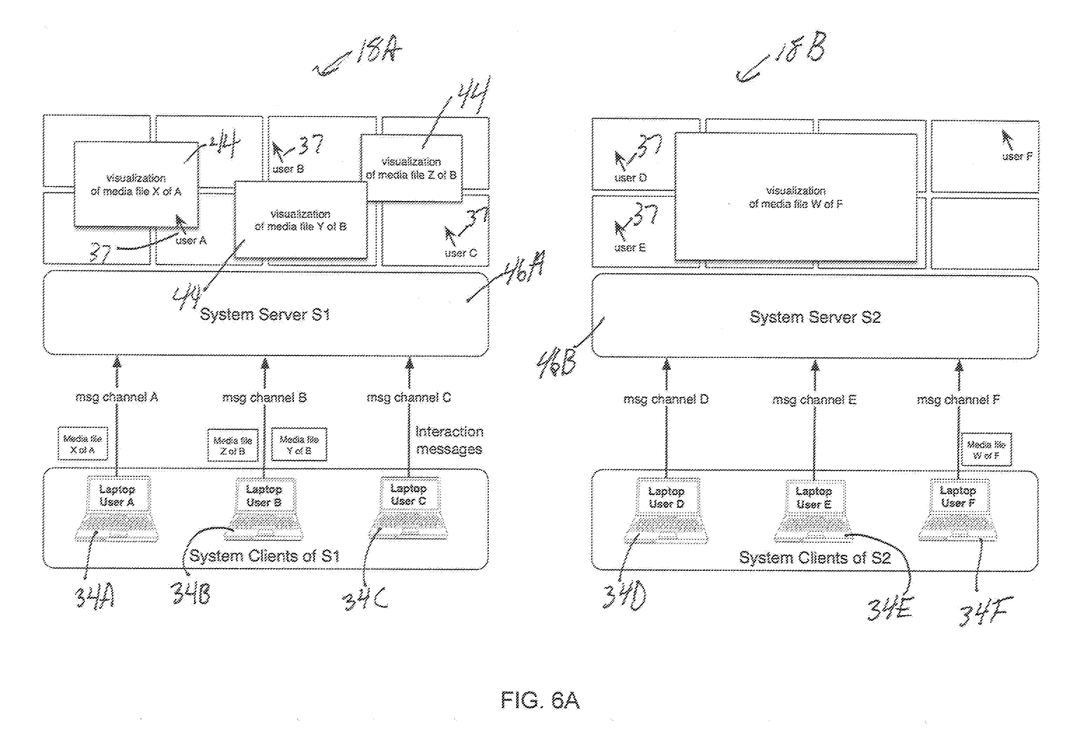

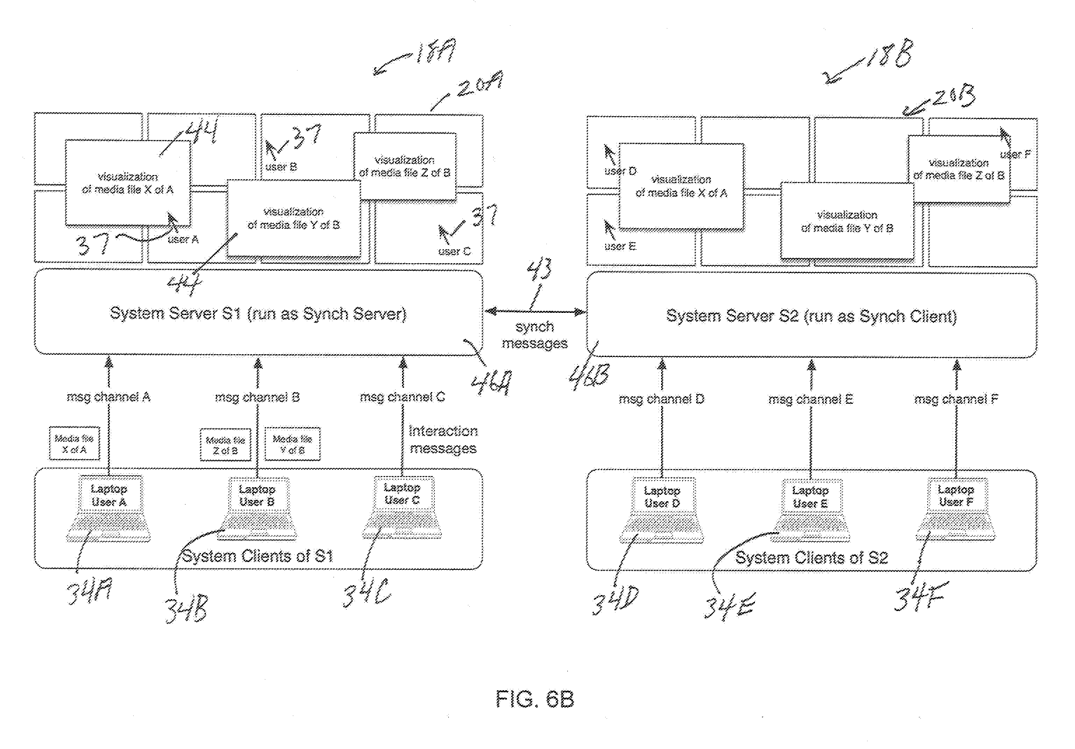

As seen in FIG. 6A, two display wall systems 18A and 18 B are illustrated and each respectively includes its own display wall 20A and 20B and system servers 46A and 46B. The system server 46A is communicatively connected to laptops 34A, 34B, and 34C. System server 46B is communicatively connected to laptops 34D, 34E, and 34F. Each of the display systems 18A and 18B are configured to operate as either standalone systems or as interdependent systems, as further described in FIG. 6B.

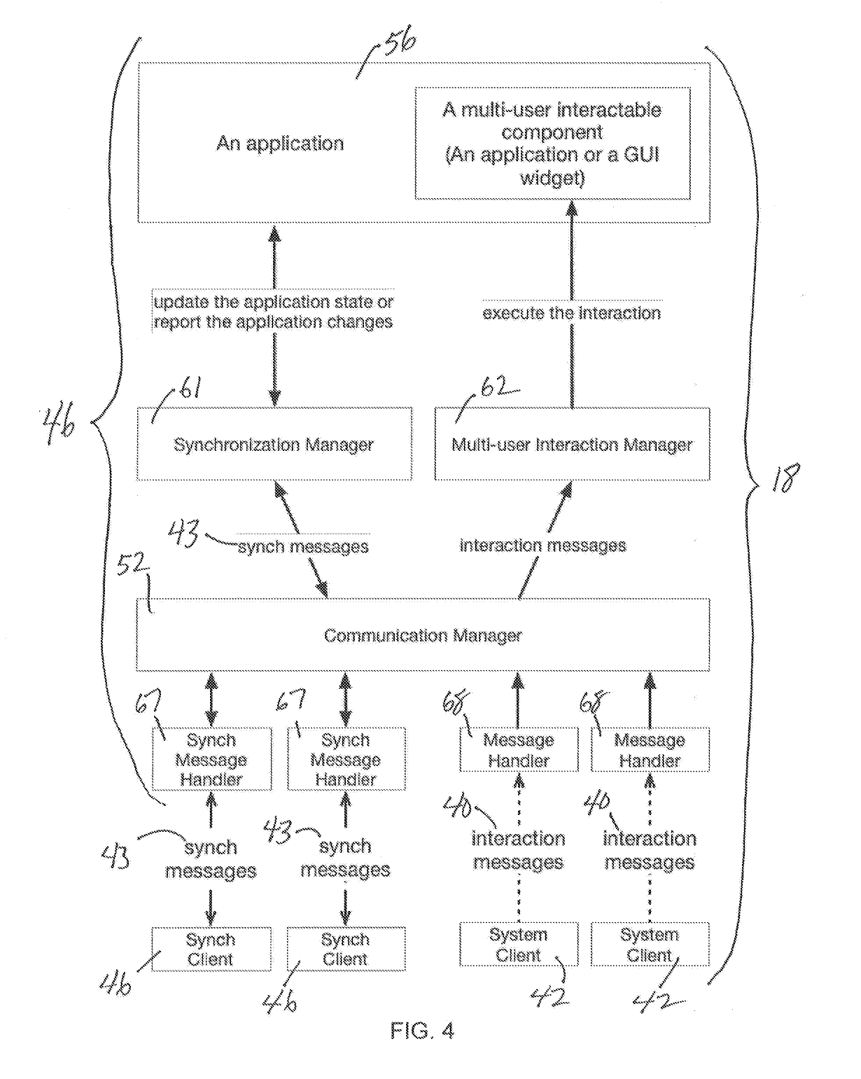

Once one of the system servers 46A or 46B receives and interprets an interaction message 40 (here transmitted by system client 34) and correspondingly interacts with the media visualization 44 on display wall 20A, then the synchronization manager 61 of system server 46A transmits synchronization messages 43 that include the result of the interactions (that is the current state of media files 44 and or applications 56) to remote system servers (in this case system server 46B), that are connected over the network and share the same Cloud storage 47 of FIG. 4. Each of the remote display wall systems 18 then receives these synchronization messages 43 and reproduce the same application states (position and size on the wall, annotations drawn on them, PDF pages that is displaying, and current video play position) 44, 56. The synchronization manager in each display wall system receives and sends synchronization messages (using the synchronization message handlers) based on the systems current operating mode (either as a synch server or a synch client).

FIG. 6B illustrates display systems 18A and 18B that are structured as synchronized display walls upon transmission of the synch message 43 by system server 46A. Media files X, Y, and Z shared by the users of the system server 46A are also displayed on the display wall 20B of display wall system 18B that is remotely located from display wall 18A. A number of remote locations are realized and include remote locations within the same building or remote locations in different buildings where access to the Cloud is available. Upon receiving user interactions of systems clients 34A, 34B, and 34C the system server 46A interacts with the files 44 on display wall 20A. If the system server 46A is connected with a remote system server, such as system server 46B, then system server 46A sends or transmits a synchronization message that contains the current states of media files X, Y, and Z displayed on display wall 20A. Once the system server 46B receives these synchronization messages, then system server 46B updates its display wall 20B, and media files X, Y, and Z are updated or revised with the state information in the messages.

Each of the servers 46A and 46B include local storage for storing files provided by each of the server's system clients. Each of the servers 46A and 46B is also operatively connected to the Cloud 47. When the servers 46A and 46B are operating independently and not synchronized to operate as a synch server and a synch client, the synchronization capability is disabled. To operate as interdependent wall systems, however, all of the media files are located in the Cloud, no matter which user uploads the files. Because of this, if the display wall systems are not currently in a synch session, the files uploaded by a user of one display wall system are visible, but not modifiable, by the other display wall systems. Once the display wall systems enter a synch session, each of the users interact with the files stored in the Cloud including having the capability to work with current visible states (geometry of visualization of the media files, current pages, or current video position) of the synchronized media files.

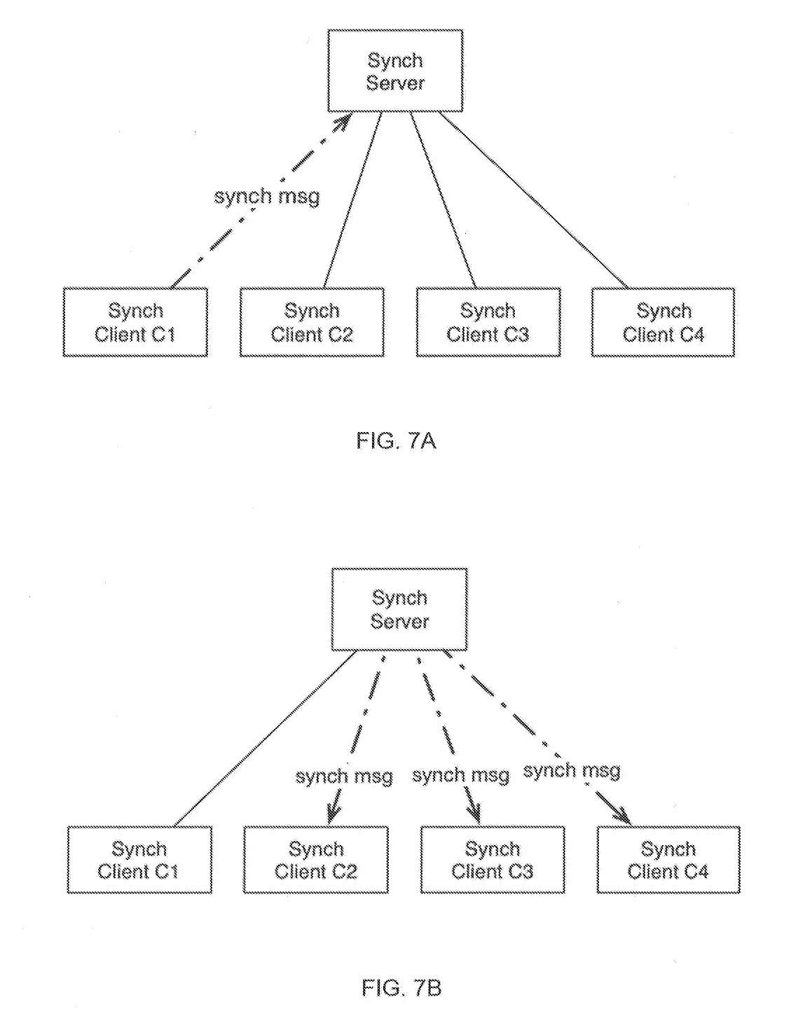

At transmission of the connection message, the server 46A is identified or becomes the synch server and the server 46B is identified as or becomes the synch client and are connected in a way to form a hub-and-spoke topology. The synch server maintains a plurality of synch message channels to serve multiple synch clients, wherein one synch message channel is maintained by the synch server for each synch client. In one embodiment, there is one or more synch clients but there is only one synch server among all connected system servers. Upon receiving synch message 43, the synch client (i.e. server 46B) receives the message, decodes (i.e. interprets) the message, and updates its display wall contents, while the synch server (i.e. 46A) receives the message and forwards the message to all the connected synch clients. This hub-and-spoke topology for the synch server and the synch clients form is depicted in FIGS. 7A and 7B. The synch server acts as the hub while each of the synch clients, identified as synch clients C1, C2, C3, and C4, at located at the spokes. The synch client transmits its local changes only to the synch server upon detecting local events that triggers the synchronization manager to send synch messages. The local events include a geometry change of a visualization of a media file (such as file 44), annotation changes of any file 44, PDF page change if file 44 is a visualization of a PDF file, video play position change if file 44 is a video. The synch server broadcasts a synch message to each of the synch clients upon detecting local synch trigger events. Upon receiving a synch message from a synch client, the synch server broadcasts the synch messages to all the remaining synch clients.

A new synch message is generated for each interaction on a media file. For example, if the visualization of media file X (the leftmost 44 of 20A of FIG. 6B) has changed its geometry (position and size) on the synch server's display wall 20A of FIG. 6B (as a result of an interaction from user A, B, or C of synch server 46A of FIG. 6B) then the synchronization manager 61 of 46A creates a new synch message that contains the unique identification of media file X and the new position and size of the visualization on its display wall 20A. This synch message is then transmitted over the network through the communication manager 52 of 46A to all the synch clients 46B connected to the synch server. The communication manager of each synch clients receives the same synch message and their synchronization managers read (i.e. interpret, parse, and decode) the message and update the position and size of the visualization of X on their display wall 20B of FIG. 6B. Please note that FIGS. 7A and B do not exactly depicts this process because the example process explained in this paragraph shows a case where a synch message was initiated from a synch server 46A of FIG. 6B. FIGS. 7A and B reflects a case when a synch message was initiated from a synch client 46B of FIG. 6B.

The overall software architecture of system 18 is understood with reference to FIG. 3, which illustrates the software structure of the system as a diagram showing major software modules that define system server 46 and each system client 42. The various core software components of system server 46 include scene layer 48; scene utilities layer 50, communication manager layer 52, and file manager 54. Core software components in scene layer 48 include: applications 56 responsible for managing instances of classes that visualize the shared media; scene renderer 58 that has a hardware accelerated graphics context that renders the scene; and scene and workspace manager 60, a global object that holds all of the application instances in workspaces. Each application supports a respective media type such as images, videos, PDF documents and live streams such as a screen mirroring (VNC). The scene represents the set of visible elements of display wall 20 and components in scene utilities layer 50 are used to bridge user interactions to scene layer 48.

Core software components in scene utilities layer 50 include: synchronization manager 61; multiuser interaction manager 62; user authenticator 64; and application factory 66.

Core software components in communication manager layer 52 include a plurality of synchronization message handlers 67 each associated with the respective synchronization managers 41 of remote systems that are running as synch clients. Note that when a system server 46 runs in synch client mode, then only one synchronization message handler 67 is active and is connected to the synchronization manager 61 of a remote system server 46 that is running as a synch server. A plurality of message handlers 68 each associated with the respective, user-specific system client 42 of a user's input device 34. User interaction message transmissions between system server 46 and the respective user input devices 34 are between the respective message handler 68 of communication manager layer 52 and the system client 42 running in the corresponding user's laptop.

File transmissions between system server 46 and the respective user input devices 34 are between file manager 54 of system server 46 and the system client 42 of each user input device 34.

One of the main goals of system server 46 is enabling a virtual collaborative graphical desktop workspace in which multiple users (multi-users) simultaneously interact with and alter the scene. Once a user communicates through communication manager layer 52, then scene utilities layer 50 takes necessary actions to alter the scene content. Multiuser interactivity is enabled mainly by communication manager layer 52 and multiuser interaction manager 62 of system server 46. Each message handler 68 in communication manager layer 52 is a separate thread that handles the communication between system server 46 and the system client 42 of a particular user. This allows the interaction messages 40 from multiple users to be received concurrently at communication manager layer 52. Communication manager layer 52 then serializes those concurrently communicated interaction messages 40 and forwards them to multiuser interaction manager 62.

The system server 46 enables synchronous display wall systems in which multiple display walls maintain the same media file visualization states. Whenever a media file visualization state changes as a result of user interactions, then the synchronization manager 61 of systems server 46 sends the synchronization messages 43 to a specific remote display wall system. If the system server 46 runs as the synch client, then the message 43 is sent to the remote display wall system that is running as the synch server. If the server 46 runs as synch server then the copies of the messages 43 are sent to all the synch client. See FIGS. 7A and 7B. Synchronization messages 43 are then sent to the synchronization manager 61 of each system 46. Synchronization manager 61 then interprets the message and update its applications 56. As result, the files 44 (rendered image of application 56) are updated.

The sharing of media files 38 through system client 42 is handled by file manager 54 of system server 46. Whenever file manager 54 receives a media file 38 of a particular type it notifies application factory 66 of scene utilities layer 50, wherein an instance of the corresponding application 56 for that file type is created. Application factory 66 then gives the application instance to scene and workspace manager 60 of scene layer 48. The application instance is visualized by scene renderer 58 of scene layer 48 and directed to display wall 20 through graphics card(s) 28, 30, 32.

FIG. 4 is a multiuser interactions diagram. Interaction messages 40 from the users' system client 42 are received individually by the message handler 68 and serialized by communication manager 52 of system server 46. Multiuser interaction manager 62 of scene utilities layer 50 then receives the serialized interaction messages and interacts with a particular component on behalf of the user. FIG. 4 shows how users' interactions are forwarded from system client 42 to system server 46 and are directed to a particular component, i.e., an application or GUI widget with which a user is interacting. The system client 42 running in each user's input device 34 captures that machine's input device events and creates interaction messages 40 describing the user's alteration to the visualized media. These interaction messages 40 are securely sent over a network (preferably a wireless network of known type) and handled by the message handler 68 of communication manager layer 52 of system server 46. The main job of communication manager 52 is to serialize the interaction messages 40 concurrently received by the plurality of message handlers 68 from their respectively associated system client 42. Once these interaction messages 40 are serialized, the serialized interaction messages 40 are delivered sequentially to multiuser interaction manager 62 of scene utilities layer 50. Multiuser interaction manager 62 then finds a component (i.e., a GUI widget or application) to interact with on the point at which the current interaction occurs, and applies the interaction on behalf of the user.

FIG. 4 also shows a plurality of remote display wall systems that are connected to server 46 and running as the synch clients. Thus the system server 46 in FIG. 4 is running as the synch server. The synch clients 46 use their respective synchronization managers 61 to send their local changes such as the position and size of visualization 44, annotations drawn on them, PDF pages being displayed, and current video play position. Upon receiving these messages at the synch server 46, the synchronization manager 61 of the synch server 46 updates the corresponding applications 56 and sends synch messages 43 to all the synch clients except the synch client that has sent the original synch message.

FIG. 5A is a block diagram of a process illustrating a synchronization procedure in the system server that is to designated as the synch server. When in the ‘start’ stage 501, the system server is neither the synch server nor the synch client. It is a display wall system 46 operating alone, with its own system server. Upon receiving a connection request from any other remote display wall system, the display wall system 46 checks if it is currently running as synch client mode. The block 502 and 503 represent this procedure.

The connection request is a tcp/ip network connection that is transmitted by the user of the display wall system. In one embodiment, the connection request is initiated by the user selecting or activating a button shown on a display wall. The user clicks the button, labeled with remote wall's name, using the graphical cursor 37 accessible at the user's laptop to which the user is connected. If the connection is made, then this user's display wall becomes the synch client. The display wall displays each of the other remote wall systems that are currently accessible and share the same Cloud storage.

At block 504, the system rejects the connection request because the server is currently running as a synch client and is connected to another server designated as a remote synch server. At block 505, the system receiving the connection request becomes a synch server, after accepting the connection. Once designated as the synch server, additional connections are made with other remote display wall systems upon receipt of connection requests to serve those systems now designated as synch clients. The synch server then receives synch messages (block 507) from any one of the synch clients, updates its own display wall (block 509), and sends the messages back to the remaining synch clients (block 508). If no changes have been received from the synch client, no further action is taken at block 510. Thus the synch server's main role is to accept connections from synch clients and propagates synch messages to them.

Block 506 determines whether the synch server has its own local changes due to the interactions from its local users 42 as seen in FIG. 4. Since the synch server is also a display wall system 18 its changes are propagated to the synch clients. Synch messages are created as a result of block 506 and sent to the synch clients. If nothing has changed locally, no action is taken at block 511. In the case where a synch client goes offline or is disconnected from the synch server, the synch server simply removes the synch message channel 43 and the corresponding handler 67 for the synch client. In the case where the synch server goes offline then all the synch message channels will be disconnected thereby all the synch clients will disconnect and operate as an individual or standalone display wall server.

FIG. 5B is a block diagram of a process illustrating a synchronization procedure in the system server that is to be designated as a synch client. When in the ‘start’ stage 521, the system server is neither the synch server nor the synch client. It is a display wall system 46 operating alone with its own system server. A system client 34 initiates its display wall system (that the system client 34 is connected to) to connect to another remote display wall system that is located remotely. A system client 34 uses his graphical cursor 37 on the display wall to which he is connected to initiate the connection. This request is made at block 522. Once the synch connection is initiated, then the other display wall system(s) accept(s) the connection at block 523 only if it is not already running as a synch client as described earlier (See block 503 of FIG. 5A). If no connection is made, the system returns to start 521.

At block 524, the display wall system that initiated the connection becomes the synch client right after the connection is made. Once the connection is made, the synch client sends synch messages whenever the state of any of file 44 changes as a result of the interactions from its local users 42 at block 525. These changes include the position and size of the file 44 changes, a new media visualization was introduced the its display wall, an existing file 44 closes, an annotation line drawn on file 44, a PDF page changes if file 44 is rendering of a PDF document, and a video play position changes if file 44 is a video. The synch message is then sent to the synch server as represented with block 527. If nothing has changed locally, no action is taken at block 529. The synch client also receives synch messages from the synch server as represented with block 526. This synch message contains the above described change that occurred either in the synch server or any one of the other synch clients. If no changes have been received, no action is taken at block 530. At block 528 the synch client updates its own display wall upon receiving the synch message from the synch server. In the cases where the synch server goes offline or the synch channel is disconnected then the synch client stops pushing its changes and operate as a standalone display wall server.

While exemplary embodiments incorporating the principles of the present invention have been disclosed hereinabove, the present invention is not limited to the disclosed embodiments. Instead, this system software is intended to cover any variations, uses, or adaptations of the invention using its general principles. Further, this system software is intended to cover such departures from the present disclosure as come within known or customary practice in the art to which this invention pertains and which fall within the limits of the appended claims.

What is claimed is:

1. A method for synchronizing a visualization layout of a media file for multiple display wall systems running multi-user, multi-content enabled display walls, each display wall system including a display wall and a system server and each of the display wall systems serving a plurality of local users, the method comprising:
identifying one of the system servers as a synch server;
identifying each of the other system servers as a synch client;
establishing, at the synch server, a plurality of synch message channels, wherein one synch message channel is maintained by the synch server for each synch client, and each of the synch message channels is configured to transmit a synch message to the synch client; and
updating a display wall content of the display wall for each of the synch clients.

2. The method of claim 1 wherein the first identifying step comprises identifying one of the system servers as a synch server in response to receiving a connection request at one of the system servers from any other system server.

3. The method of claim 2 wherein the second identifying step comprises identifying each of the other system servers as synch clients based on the connection request received at the system server identified as the synch server.

4. The method of claim 2 further comprising:
receiving at the synch server plurality of messages transmitted by one or more of the synch clients, each of the plurality of messages including a change to the visualization layout of the media file, wherein the change to the media file results from a user input device operatively connected a respective one of the synch clients.

5. The method of claim 4 further comprising:
transmitting from the synch server, in response to one of the received plurality of messages, a synch message to each of the synch clients, but not to the synch client transmitting the one of the received plurality of messages, wherein the transmitted synch message provides a change to the visualization layout.

6. The method of claim 5 further comprising updating the visualization layout of each the display walls of each of the display wall systems in response to the transmitted synch message providing a change the visualization layout.

7. The method of claim 6 further comprising removing the synch message channel between the synch server and one of the synch clients if the one of the synch clients is disconnected from the synch server.

8. The method of claim 6 further comprising removing the synch message channel between each of the synch clients and the synch server if the synch server goes offline such that each of the display wall systems operate as individual standalone display wall systems.

9. A media file display wall system for displaying one or more media files provided by a plurality of computing devices each interacting with the media file display wall system at the discretion of a user, the system comprising:
a first display wall including a synch server, wherein the synch server is operatively connected to the first display wall, to one or more first user input devices, and to a cloud network;
a plurality of second display walls each including a synch client, wherein each of the synch clients is operatively connected to one or more second user input devices and to the cloud network; and
a plurality of synch message channels maintained by the synch server and each of the plurality of synch message channels operatively connected to one of the plurality of synch clients, wherein the synch message channels transmit an updated message to update the media file located at each of the plurality of second display walls, except to the synch client of the one of the plurality of display walls transmitting the message to the synch server.

10. A method for synchronizing media file visualization states of media files for multiple display wall systems each running multi-user, multi-content enabled display walls, each of the display wall systems operatively connected to plurality of local users each having an input device, the method comprising:
receiving, at a first display wall of the display wall systems, a connection request from a second display wall of the display wall systems, wherein the connection request requests the first display wall to operate in a synch server mode;
determining, at the first display wall, whether the first display wall is operating in a synch client mode;
accepting, at the first display wall, the connection request to operate in the synch server mode, if the first display wall is not operating in the synch client mode; and
not accepting, at the first display wall, the connection request to become the synch server, if the first display wall is operating in they synch client mode.

11. The method of claim 10 wherein the first display wall and the second display wall are operatively connected to the cloud and the media files are stored on the cloud.

12. The method of claim 10 further comprising operating the second display wall in the synch client mode if the first display wall accepts the connecting request to operate in the synch server mode.

13. The method of claim 12 receiving, at the first display wall of the display wall systems, another connection request from a third display wall of the display wall systems, wherein the another connection request requests the first display wall to operate in a synch server mode.

14. The method of claim 13 further comprising accepting at the first display wall the another connection request to operate in the synch server mode, if the first display wall system is not operating in the synch client mode.

15. The method of claim 14 further comprising operating the third display wall system in the synch client mode if the first display wall accepts the connection request to operate in the synch server mode.

16. The method of claim 15 further comprising:
receiving at the first display wall system an interaction message from an input device operatively connected to the first display wall system; and
updating a media file visualization in response to the interaction message.

17. The method of claim 16 further comprising:
transmitting from the first display wall system in response to the received interaction message a synchronization message to the third display wall system to indicate to the third display wall system that the media file visualization is updated.

18. The method of claim 17 further comprising:
receiving, at the first display wall of the display wall systems, a synchronization request from the third display wall system, and
updating the media file visualization based on the synchronization request received from the third display wall system.

19. The method of claim 10 wherein each of the display wall systems include a system server and a display wall, wherein the system server is configured to operate as one of a synch server or a synch client.

20. The method of claim 19 wherein each of the system servers is an integrated system server.
